(19) United States
(12) Patent Application Publication
(10) Pub. No.: US 2026/0067902 A1
(43) Pub. Date: Mar. 5, 2026

(54) TRANSMISSION CONFIGURATIONS FOR TRANSMISSION IN SIDELINK

(71) Applicant: QUALCOMM Incorporated, San Diego, CA (US)

(72) Inventors: Stelios STEFANATOS, San Diego, CA (US); Chih-Hao LIU, San Diego, CA (US); Gabi SARKIS, San Diego, CA (US); Guangyi LIU, Shanghai (CN); Giovanni CHISCI, San Diego, CA (US); Tien Viet NGUYEN, Bridgewater, NJ (US); Xiaoxia ZHANG, San Diego, CA (US)

(21) Appl. No.: 19/103,637

(22) PCT Filed: Nov. 3, 2022
(86) PCT No.: PCT/CN2022/129422

§ 371 Date: Feb. 13, 2025

(51) Int. Cl. H04W 72/25; H04L 5/00; H04W 64/00

(52) U.S. Cl. CPC H04W 72/25; H04L 5/0094; H04W 64/00

(57) ABSTRACT

Various aspects of the present disclosure generally relate to wireless communication. In some aspects, a user equipment (UE) may receive information identifying a subset of transmission configurations of a set of possible transmission configurations for a sidelink resource pool with a plurality of transmission starting positions. The UE may transmit, in a transmission starting position of the plurality of transmission starting positions and on a sidelink, using a transmission configuration of the subset of transmission configurations. Numerous other aspects are described.

### FIELD OF THE DISCLOSURE

Aspects of the present disclosure generally relate to wireless communication and to techniques and apparatuses for transmission configurations for transmission in sidelink.

### BACKGROUND

Wireless communication systems are widely deployed to provide various telecomnmnication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving information identifying a subset of transmission configurations of a set of possible transmission configurations for a sidelink resource pool with a plurality of transmission starting positions. The method may include transmitting, in a transmission starting position of the plurality of transmission starting positions and on a sidelink, using a transmission configuration of the subset of transmission configurations.

Some aspects described herein relate to a UE for wireless communication. The user equipment may include a memory and one or more processors coupled to the memory. The one or more processors may be configured to receive information identifying a subset of transmission configurations of a set of possible transmission configurations for a sidelink resource pool with a plurality of transmission starting positions. The one or more processors may be configured to transmit, in a transmission starting position of the plurality of transmission starting positions and on a sidelink, using a transmission configuration of the subset of transmission configurations.

Some aspects described herein relate to a non-transitory computer-readable medium that stores a set of instructions for wireless communication by a UE. The set of instructions, when executed by one or more processors of the UE, may cause the UE to receive information identifying a subset of transmission configurations of a set of possible transmission configurations for a sidelink resource pool with a plurality of transmission starting positions. The set of instructions, when executed by one or more processors of the UE, may cause the UE to transmit, in a transmission starting position of the plurality of transmission starting positions and on a sidelink, using a transmission configuration of the subset of transmission configurations.

Some aspects described herein relate to an apparatus for wireless communication.

The apparatus may include means for receiving information identifying a subset of transmission configurations of a set of possible transmission configurations for a sidelink resource pool with a plurality of transmission starting positions. The apparatus may include means for transmitting, in a transmission starting position of the plurality of transmission starting positions and on a sidelink, using a transmission configuration of the subset of transmission configurations.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of channel access procedures, in accordance with the present disclosure.

FIG. 7 is a diagram illustrating an example of physical sidelink channel starting positions, in accordance with the present disclosure.

FIGS. 8A and 8B are diagrams illustrating an example associated with transmission configurations for transmission in sidelink, in accordance with the present disclosure.

FIG. 9 is a diagram illustrating an example process performed, for example, by a UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

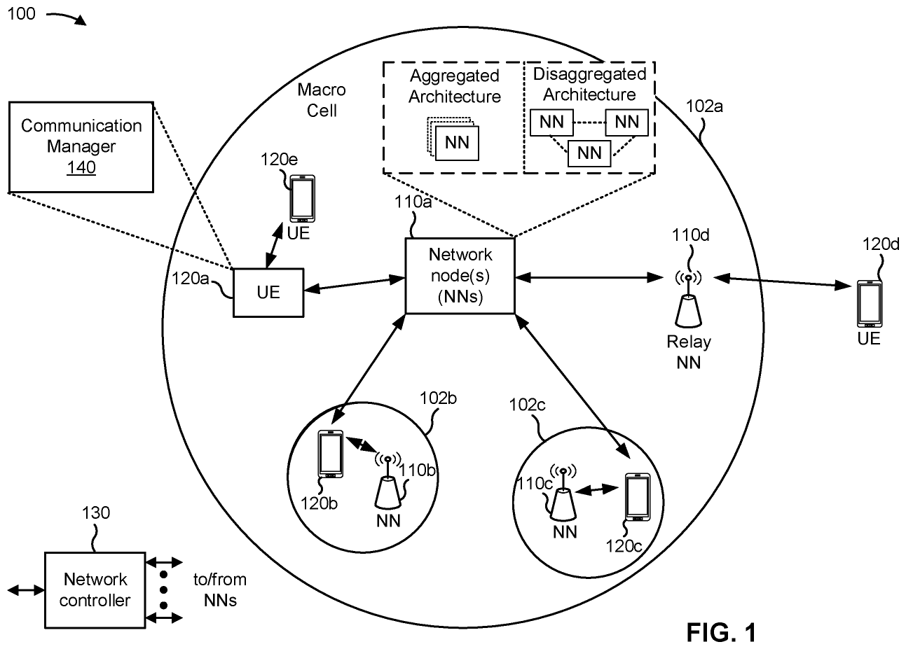

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cel may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another.

In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz).

Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information identifying a subset of transmission configurations of a set of possible transmission configurations for a sidelink resource pool with a plurality of transmission starting positions; and transmit, in a transmission starting position of the plurality of transmission starting positions and on a sidelink, using a transmission configuration of the subset of transmission configurations. Additionally, or alternatively, the communication manager 140 may perform one or more other operations described herein.

As indicated above, FIG. 1 is provided as an example. Other examples may differ from what is described with regard to FIG. 1.

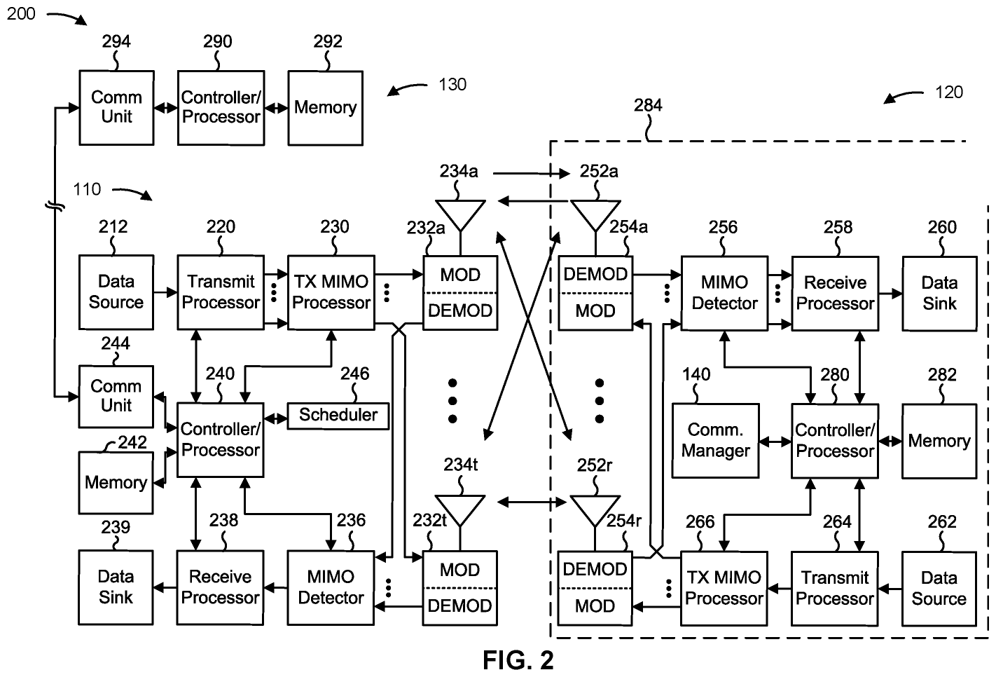

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The tansmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

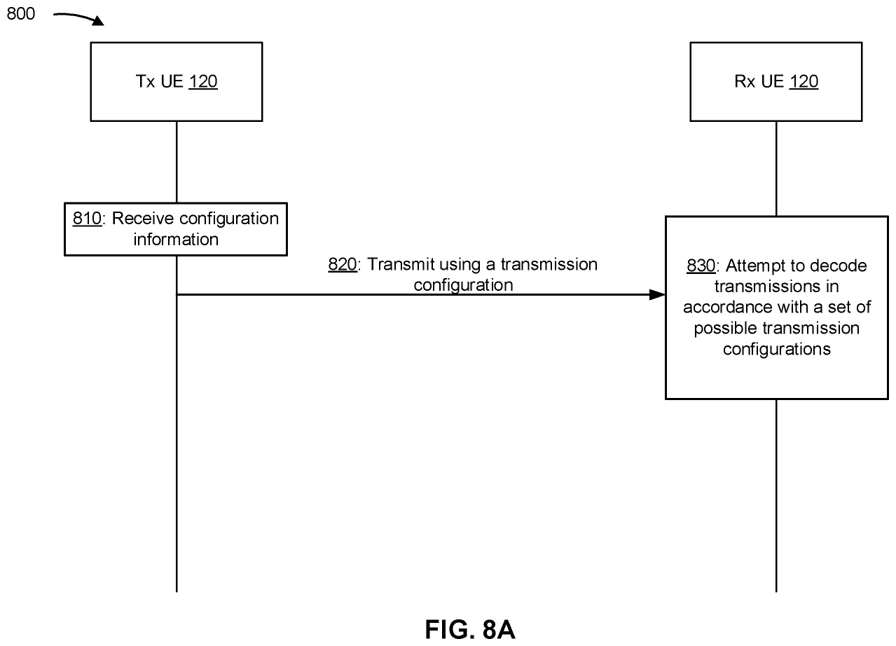

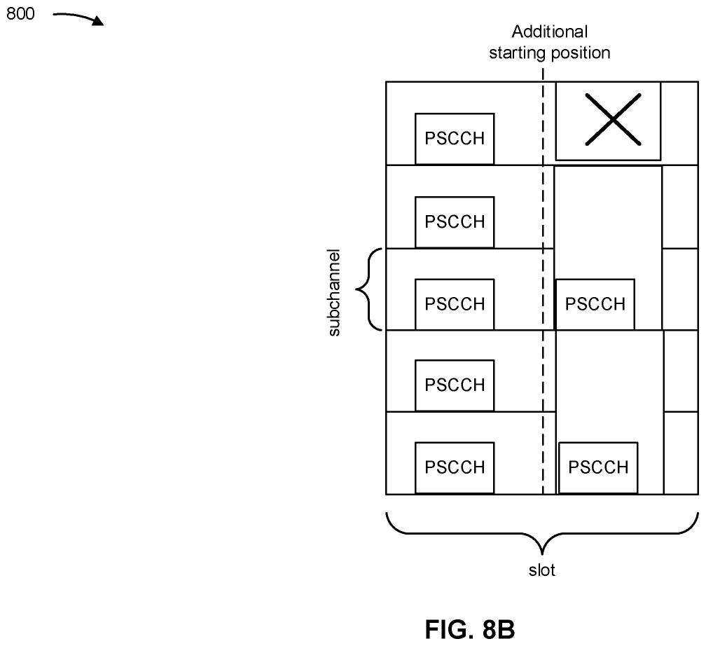

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8A-10).

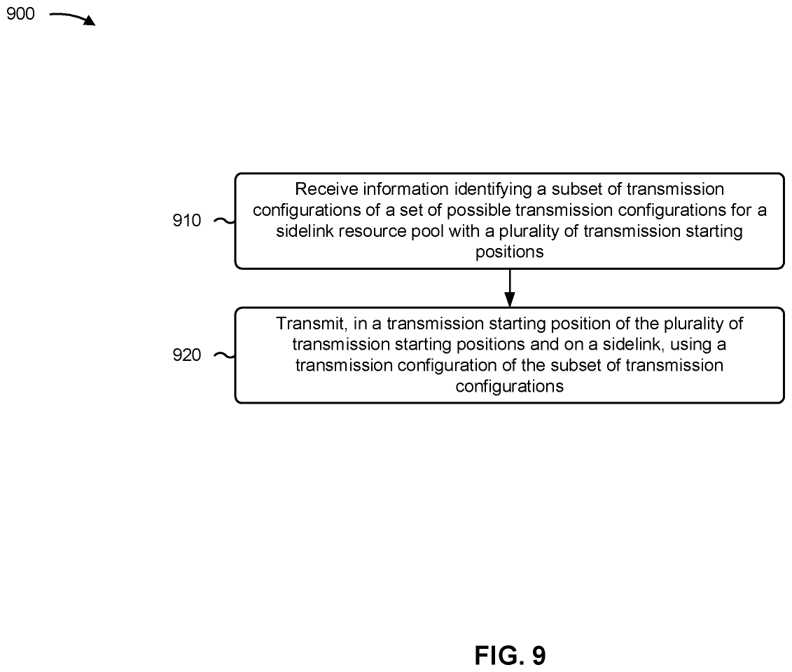

The controller/processor 240 of the network node 110, the controller/processor 280 of the UE 120, and/or any other component(s) of FIG. 2 may perform one or more techniques associated with transmission in sidelink, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of for example, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving information identifying a subset of transmission configurations of a set of possible transmission configurations for a sidelink resource pool with a plurality of transmission starting positions; and/or means for transmitting, in a transmission starting position of the plurality of transmission starting positions and on a sidelink, using a transmission configuration of the subset of transmission configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

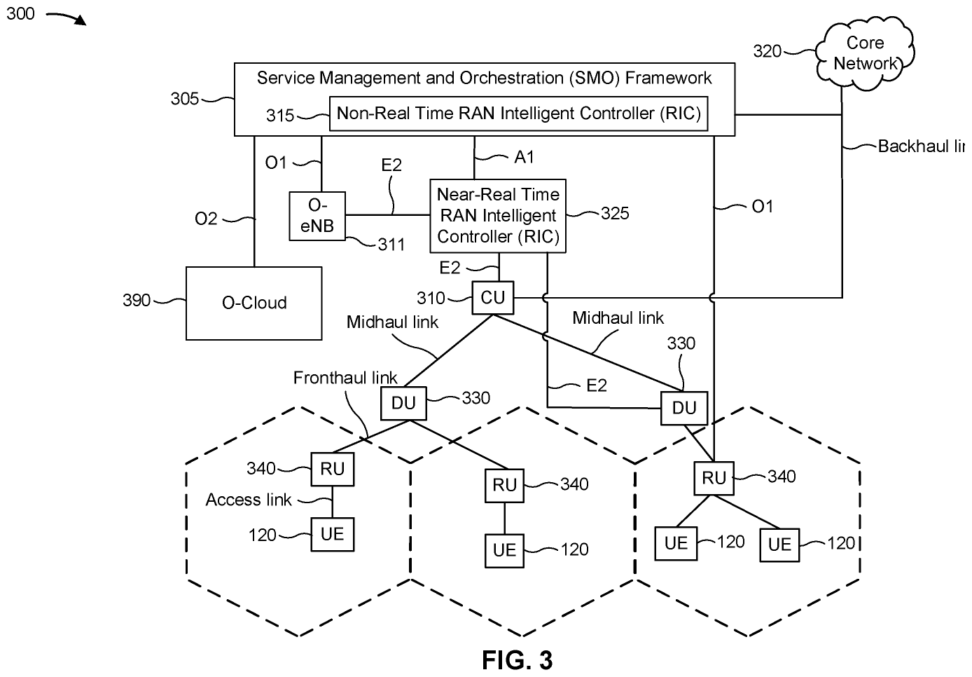

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium.

Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split.

In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

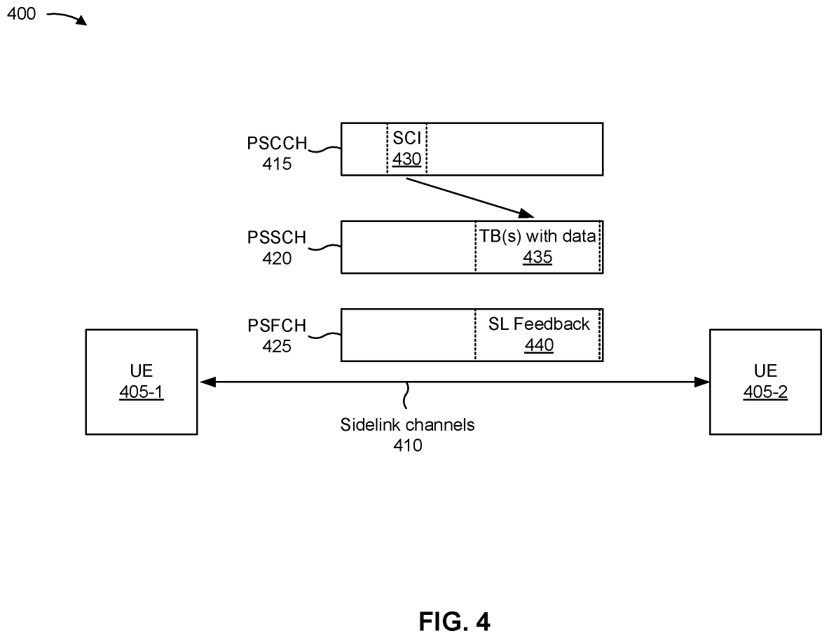

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some examples, the UEs 405 (e.g., UE 405-1 and/or UE 405-2) may correspond to one or more other UEs described elsewhere herein, such as UE 120. In some examples, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some examples, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some examples, the one or more sidelink channels 410 may use resource pools.

For example, a scheduling assignment (e.g., included in SCI 430) may be transmitted in sub-channels using specific resource blocks (RBs) across time. In some examples, data transmissions (e.g., on the PSSCH 420) associated with a scheduling assignment may occupy adjacent RBs in the same subframe as the scheduling assignment (e.g., using frequency division multiplexing). In some examples, a scheduling assignment and associated data transmissions are not transmitted on adjacent RBs.

In some examples, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some examples, a UE 405 may operate using a transmission mode (e.g., Mode 2) where resource selection and/or scheduling is performed by the UE 405 (e.g., rather than a network node 110). In some examples, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some examples, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

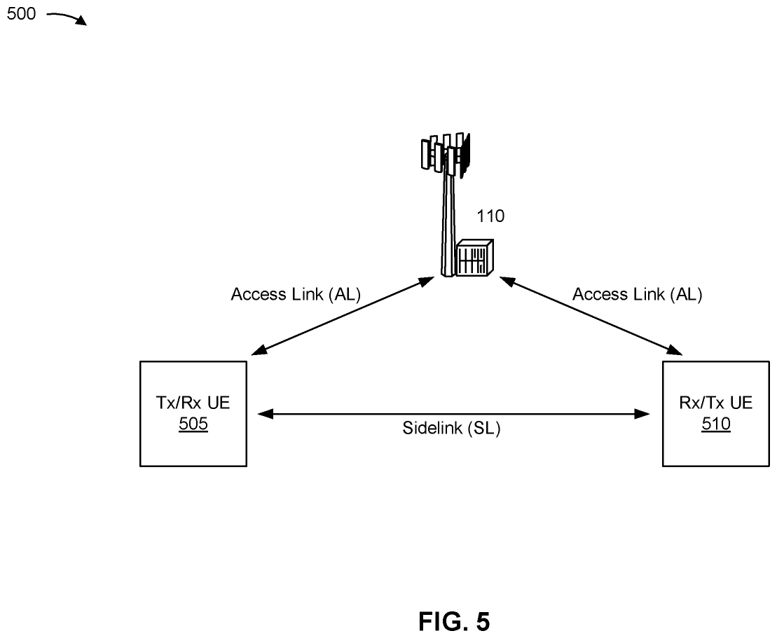

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4.

As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

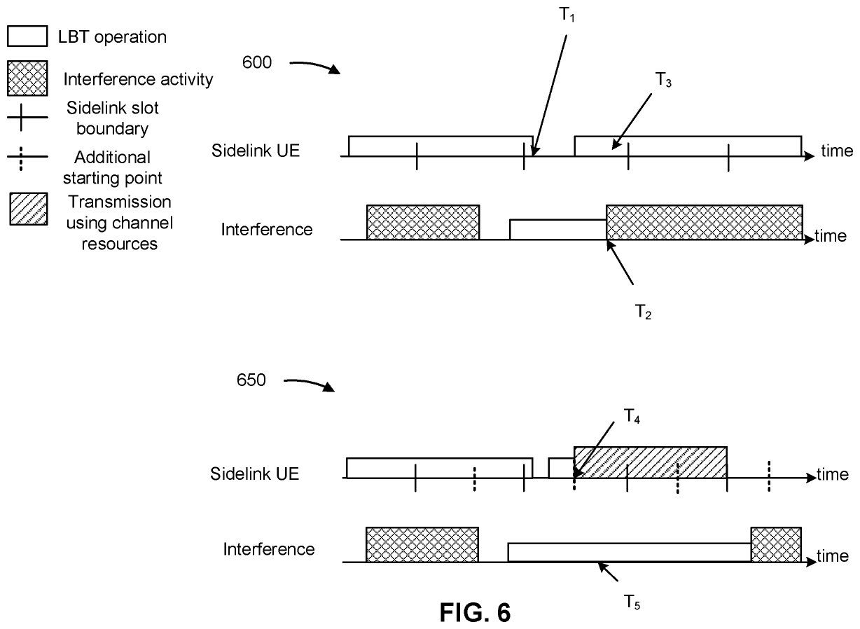

FIG. 6 is a diagram illustrating examples 600 and 650 of channel access procedures, in accordance with the present disclosure.

As shown in example 600, a UE may perform a contention based access procedure, such as a listen-before-talk (LBT) operation, to attempt to access resources of a channel. The LBT operation may occur for a particular period of time that crosses a set of slot boundaries. At a first time, T₁, the UE finishes the LBT operation and identifies the channel as idle. In this case, the sidelink slot boundary has already passed, so the UE is unable to use the channel for transmission. Accordingly, the UE is configured to wait for a next transmission opportunity, at a next slot boundary, to tansmit. At a second time, T₂, interference activity is initiated, as the channel is not being used. Accordingly, at a third time, T₃, the UE detects the interference activity and is unable to transmit in a next transmission opportunity.

As shown in example 650, additional starting positions, which may also be referred to as starting positions, are introduced to provide more frequent transmission opportunities for the UE. In this case, at a fourth time, T₄, the UE successfully completes an LBT operation and begins transmitting at one of the additional starting positions (e.g., between slot boundaries). Accordingly, at a fifth time, T₅, another UE performing an LBT procedure can determine that the channel is busy, and defer to the transmissions already occurring, as shown. In this case, by providing additional starting positions, UEs can use more of a channel's resources (rather than some resources going unused as no UE is able to start transmission at a time to use the resources), thereby improving network efficiency.

As indicated above, FIG. 6 is provided as an example. Other examples may differ from what is described with respect to FIG. 6.

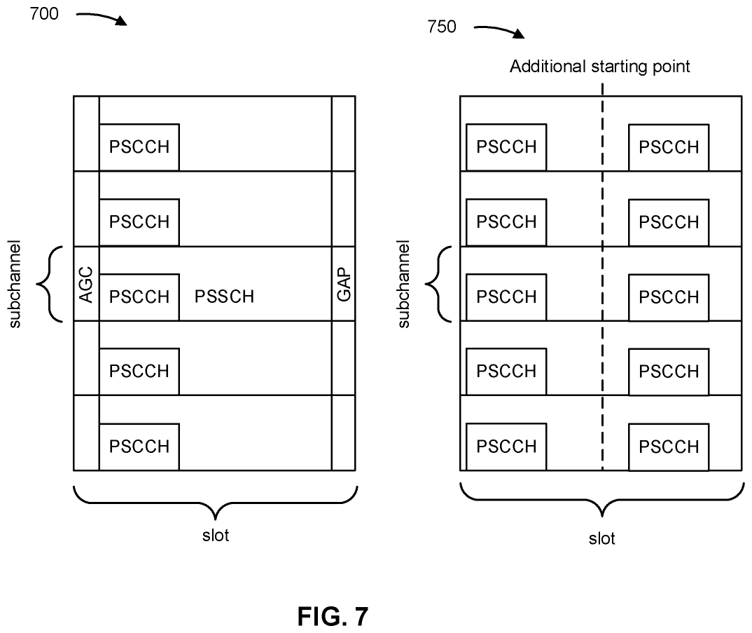

FIG. 7 is a diagram illustrating examples 700 and 750 of physical sidelink channel starting positions, in accordance with the present disclosure.

As by example 700, a sidelink resource pool can be divided into a set of resource pool subchannels for sidelink communication. Each subchannel may have an automatic gain control (AGC) period, a PSCCH transmission period, a PSSCH transmission period, and a gap period, among other examples. UEs can be configured to start PSCCH transmission at a beginning of the PSCCH transmission period (e.g., at a start-of-slot starting position). In contrast, in example 750, when an additional starting position is introduced, a UE may start PSCCH transmission at a first transmission opportunity at a beginning of the PSCCH transmission period and a second transmission opportunity during a period (e.g., that can then be used for a PSCCH transmission period and/or a PSSCH transmission period). Although some examples are described in terms of one additional starting position being added between pairs of start-of-slot starting positions, additional quantities of starting positions may be possible.

As indicated above, FIG. 7 is provided as an example. Other examples may differ from what is described with respect to FIG. 7.

Adding additional starting positions (e.g., mid-slot starting positions occurring between start-of-slot or slot-boundary starting positions) can increase channel efficiency by increasing a likelihood that a transmit UE is able to start transmitting using an available resource. However, introducing additional starting positions can increase decoding complexity at a receive UE side. The receive UE may not know which starting position the transmit UE will use and, accordingly, will attempt to decode a PSCCH over all possible starting positions. In other words, increasing a quantity of possible starting positions, increases a quantity of decode attempts by the receive UE, which can result in increased usage of power or processor resources. When the receive UE is monitoring a plurality of subchannels (e.g., 5 subchannels of a single resource pool), the receive UE may attempt to decode a PSCCH over all possible starting positions on the plurality of subchannels. Accordingly, if the quantity of starting positions is doubled (e.g., by introducing one mid-slot starting position on each subchannel), the receive UE may attempt to decode a PSCCH at 10 different possible transmission opportunities for a single slot (e.g., 2 transmission opportunities in the single slot on each of the 5 subchannels).

UE capability signaling may be used to indicate whether UEs have sufficient processing and/or power resources to support additional starting positions for sidelink communications, such as PSCCH transmissions or PSSCH transmissions. In such a scenario, a UE may indicate whether the UE is capable of supporting additional starting positions and, when the UE is not capable of supporting additional starting positions, links being used by the UE may not use the additional starting positions. However, limiting which links can use additional starting positions may reduce network efficiency. Moreover, communicating a UE capability may utilize network resources, which may further reduce network efficiency.

In some communications systems, all UEs may be capable of satisfying a minimum quantity of decodes of PDCCHs (per slot) for Uu operation. For example, 5G NR UEs may have a capability of a minimum of 44 PDCCH decodes per slot with a 15 kilohertz (KHz) subcarrier spacing (SCS) and 32 PDCCH decodes per slot with a 30 kHz SCS. Accordingly, the UEs may have, at minimum, the same capability for PSCCH decodes in sidelink operation. Considering the Uu-based minimum capability, additional starting positions may be supported under certain resource pool configurations. For example, with one fixed, additional starting position being introduced across a full slot, UEs can support 20 megahertz (MHz) or 40 MHz of bandwidth for SCSs of 15 kHz (e.g., 10 subchannels per 20 MHz) or 30 kHz (e.g., 5 subchannels per 20 MHz). In contrast, the UE may not be able to support bandwidths of 80 MHz or 100 MHz, as shown in the table below:

TABLE 1

| | BW 20 MHz | 40 MHz | 80 MHz | 100 MHz |
|---|---|---|---|---|
| SCS 15 kHz | 20 decodes | 40 | 80 | 100 |
| SCS 30 kHz | 10 | 20 | 40 | 50 |

As shown in the Table 1, for bandwidths of 20 MHz and 40 MHz, a resulting quantity of PSCCH decodes is smaller than the Uu-based minimum capability. However, for larger bandwidths (e.g., greater than 40 MHz), a quantity of PSCCH decodes exceeds the Uu-based minimum capability. It is possible to limit transmissions that do not initiate at the slot boundary to full bandwidth transmissions. In other words, a start-of-slot starting position can be configured across all subchannels of a channel, but a mid-slot starting position can be restricted to a subset of subchannels of the resource pool, thereby decreasing a quantity of decodes for a receive UE (e.g., that is aware of the limitation). In this case, a receive UE may attempt to decode one PSCCH per subchannel in a resource pool associated with a start-of-slot starting position and only a single additional PSCCH associated with a mid-slot starting position (e.g., which may occur anywhere after the start and prior to the end of the slot, such as at a middle of the slot or another part of the slot). However, this may limit a usage of a channel for mid-slot starting positions to only a small subset of subchannels to maintain low receiver complexity.

Some aspects described herein enable transmission configuration for transmission in sidelink. For example, a transmit UE may receive information configuring a subchannel configuration of a set of possible transmission configurations. Each possible transmission configuration may have a corresponding additional PSCCH starting position, which may be indicated in a resource pool configuration or slot configuration associated with or included in the transmission configuration. Accordingly, a quantity of additional PSCCH decodes by the receive UE is limited to the quantity of possible transmission configurations with which the transmit UE is configured. In this way, the transmit UE can use additional channel resources relative to a single starting position or a fixed mapping of additional starting positions without excessively increasing decoding complexity at a receive UE, such that the receive UE does not have a sufficient capability (e.g., sufficient processing resources or power resources) to satisfy the decoding complexity.

FIGS. 8A and 8B are diagrams illustrating an example 800 associated with transmission configurations for transmission in sidelink, in accordance with the present disclosure. As shown in FIG. 8A, example 800 includes communication between a network node 110 and a transmit UE 120 and a receive UE 120.

As further shown in FIG. 8A, and by reference number 810, the transmit UE 120 may receive configuration information. For example, the transmit UE 120 may receive configuration information identifying a set of transmission configurations and/or a selection of a transmission configuration from the set of transmission configurations. In some aspects, the receive UE 120 may receive information identifying the set of transmission configurations. For example, the transmit UE 120 and/or the receive UE 120 may receive radio resource control (RRC) signaling identifying a set of entries in a look-up table corresponding to a set of possible transmission configurations. Additionally, the transmit UE 120 (and/or the receive UE 120) may receive information identifying a particular entry in the lookup table as a transmission configuration to select for transmission. Additionally, or alternatively, the transmit UE 120 and/or the receive UE 120 may be statically configured with information associated with the set of transmission configurations. For example, the transmit UE 120 and/or the receive UE 120 may be statically configured with the lookup table from which to identify the set of transmission configurations or a selected transmission configuration thereof.

In some aspects, a transmission configuration may include a transmission configuration. For example, the transmission configuration may include information identifying one or more additional starting positions in one or more subchannels that the transmit UE 120 can use for transmission. In some aspects, there is a one-to-one mapping between transmission configurations and PSCCH occasions.

In some aspects, the transmit UE 120 (and/or the receive UE 120) may receive a bitmap identifying a set of possible transmission configurations. For example, the transmit UE 120 may receive a bitmap with an Xth bit of the bitmap corresponding to an Xth subchannel in a resource pool and a value of the Xth bit indicating whether the Xth subchannel is used or not in a particular transmission configuration. In this case, as an example, for a resource pool of 5 subchannels with N=3 possible transmission configurations, the transmit UE 120 and the receive UE 120 may receive a set of bitmaps 11000, 00110, and 0001. The set of bitmaps indicate that a first and second subchannel are used for the first transmission configuration, a third and fourth subchannel are used for a second transmission configuration, and a fifth subchannel is used for a third transmission configuration. In this case, the receive UE 120 may perform 3 PSCCH decode attempts corresponding to each of the three valid configurations to successfully receive a PSCCH. For example, the receive UE 120 may perform a first PSCCH decode attempt in the first subchannel (which, if successful, indicates that the first transmission configuration is being used), a second PSCCH decode attempt in the third subchannel (which, if successful, indicates that the second transmission configuration is being used), and a third PSCCH decode attempt in the fifth subchannel (which, if successful, indicates that the third transmission configuration is being used). In this way, the receive UE 120 can forgo PSCCH decode attempts in the second and fourth subchannels.

In some aspects, a transmission configuration may be applicable for operation over a plurality of resource block (RB) sets (e.g., each of which may be associated with a 20 MHz bandwidth). For example, the transmit UE 120 may be configured with transmission configurations that are applicable to a single RB set (e.g., the size of a bitmap identifying a transmission configuration is based at least in part on the quantity of subchannels in each RB set). In this case, if a transmission is to occupy a plurality of RB sets, the transmit UE 120 may use the same transmission configuration for the plurality of RB sets. Additionally, or alternatively, the transmit UE 120 may use different transmission configurations for different RB sets (e.g., which may increase receive UE decode complexity, but may increase resource utilization flexibility). Additionally, or alternatively, the transmit UE 120 may be configured with sets of possible transmission configurations for each RB set and may select a single transmission configuration for a plurality of RB sets that is common to a plurality of sets of possible transmission configurations for the plurality of RB sets. In other words, if each RB set has a corresponding set of possible transmission configurations and there is a transmission configuration common to each of the corresponding sets of possible transmission configurations, the transmit UE 120 may select the common transmission configuration to use across the plurality of RB sets. Alternatively, the transmit UE 120 may select configurations independently for each RB set from each corresponding set of possible transmission configurations. Additionally, or alternatively, the transmit UE 120 may be configured with possible transmission configurations that cover a whole bandwidth part (e.g., covering the plurality of RB sets). In this case, a bitmap identifying a transmission configuration may have a size based at least in part on a quantity of subchannels in the whole bandwidth part. As a result, the transmit UE 120 can select a single transmission configuration to cover all RB sets in the bandwidth part.

In some aspects, the set of possible transmission configurations may be associated with one or more common criteria. For example, each transmission configuration may have a minimum quantity of contiguous subchannels. In this case, for a resource pool of 5 subchannels with a minimum quantity of 4 contiguous subchannels, the set of possible transmission configurations may be represented by 3 bitmaps 11110, 01111, and 11111. However, by receiving configuration information indicating parameters of a minimum quantity of 4 contiguous subchannels and a resource pool of 5 subchannels, the transmit UE 120 and the receive UE 120 can infer the set of transmission configurations without receiving the aforementioned 3 bitmaps (e.g., as the 3 transmission configurations are the only possible transmission configurations given the aforementioned parameters). In other words, when a minimum number of contiguous subchannels parameter is configured (or some other limiting parameter), an amount of overhead to signal a set of possible transmission configurations can be reduced. Another example of a parameter may include a minimum quantity of subchannels configured for each transmission configuration (e.g., which may not necessarily be contiguous). In some aspects, such a restriction on transmission configurations may be applicable to a plurality of RB sets, as described above. For example, the same restriction and associated transmission configurations may be used across a plurality of RB sets, the same restriction but different associated transmission configurations may be used across a plurality of RB sets, or different RB sets may have different (or no) restrictions and associated transmission configurations, among other examples. Additionally, or alternatively, when RB sets are configured with different restrictions (e.g., a different minimum quantities of subchannels in a transmission configuration), the transmit UE 120 may select a common configuration, for all RB sets, that satisfies a most stringent restriction of the different restrictions. In other words, when a first RB set has a restriction for a first transmission configuration with at least 2 subchannels and a second RB set has a restriction for a second transmission configuration with at least 3 subchannels, the UE 120 may use a transmission configuration with 3 or more subchannels for both RB sets to satisfy both restrictions. In another case, the transmit UE 120 may select different transmission configurations for each RB set independently based at least in part on corresponding restrictions on transmission configurations for each RB set.

In some aspects, the transmit UE 120 and the receive UE 120 may receive or be configured with configuration information identifying transmission configurations with a subset of subchannels available within a resource pool. In this case, a resource pool may allow transmissions over additional starting symbols with a starting subchannel selected from a subset of the subchannels available, thereby enabling the receive UE 120 to attempt to decode PSCCH in the subset of the subchannels rather than the entirety of the subchannels. As an example, for a resource pool of 5 subchannels, the transmit UE 120 may have transmission configurations for using, as a starting subchannel, one of subchannels 1, 3, or 5 (and not subchannels 2 or 4), thereby enabling the receive UE 120 to limit PSCCH decodes to subchannels 1, 3, or 5 for the additional starting position. In some aspects, the transmit UE 120 may be configured with the aforementioned restriction for a plurality of resource block sets. In this case, the transmit UE 120 may use the same starting subchannel (within the restricted set) for different RB sets, different starting subchannels (within the restricted set) for different RB sets, the same starting subchannel that is common to a plurality of restricted sets for a plurality of RB sets, or different starting subchannels selected from within different restricted sets for different RB sets, among other examples.

In some aspects, the transmit UE 120 and the receive UE 120 may receive transmission configuration information identifying a different subchannel size for different starting positions. For example, as shown in FIG. 8B, the transmit UE 120 and receive UE 120 may be configured with a first subchannel size (resulting in 5 available subchannels) for a first starting position (e.g., start-of-slot starting position) and a second subchannel size (resulting in 2 available subchannels) for a second starting position (e.g., a mid-slot starting position). In this case, by increasing a subchannel size for additional starting positions, a quantity of PSCCH occasions is decreased, thereby decreasing a quantity of PSCCH decodes by the receive UE 120.

Although FIG. 8B shows an example of contiguous RB-based subchannels, some aspects described herein may be applicable to interlaced RB-based subchannels.

As further shown in FIG. 8A, and by reference number 820, the transmit UE 120 may transmit using a transmission configuration. For example, the transmit UE 120 may select a particular transmission configuration and may transmit in accordance with the particular transmission configuration. In this case, the transmit UE 120, when transmitting on a sidelink using an additional starting position, may transmit using one or more subchannels corresponding to the transmission configuration.

In some aspects, the transmit UE 120 may select the transmission configuration based at least in part on a received indication. For example, the transmit UE 120 may receive an indication of an entry in a look-up table and may select a transmission configuration corresponding to the entry in the look-up table, as described above. Additionally, or alternatively, the transmit UE 120 may autonomously select a transmission configuration from the set of transmission configurations. For example, when the transmit UE 120 determines that a first transmission configuration has been reserved (e.g., by another transmit UE), the transmit UE 120 may select a second transmission configuration (e.g., that is non-overlapping with the first transmission configuration to avoid interference or failure to access a channel).

In some aspects, the transmit UE 120 may transmit in any starting position in accordance with the transmission configuration (e.g., in a start-of-slot starting position as well as in a mid-slot additional starting position, as described above). For example, the transmit UE 120 may transmit in a start-of-slot starting position in one or more subchannels associated with a selected transmission configuration. In this case, the receive UE 120 can restrict PSCCH decodes for the start-of-slot starting position to only subchannels in accordance with a possible transmission configuration. In this way, a further reduction in PSCCH decodes and associated search space is achieved, thereby further reducing receive UE decode complexity. Moreover, applying the set of possible transmission configurations to all starting positions may increase procedural consistency for resource reservation, which may reduce processing complexity and/or an amount of code that is stored to enable resource reservation.

As further shown in FIG. 8A, and by reference number 830, the receive UE 120 may attempt to decode transmissions in accordance with the set of possible transmission configurations. For example, the receive UE 120 may attempt PSCCH decoding in a set of starting positions associated with the set of possible transmission configurations to attempt to receive the transmission from the transmit UE 120. In this case, when there are a quantity N possible transmission configurations, the receive UE 120 may attempt N extra PSCCH decodes for each additional starting position in a slot. In other words, if a slot has 5 subchannels each with 1 start-of-slot starting position and 1 mid-slot additional starting position and there are 3 possible transmission configurations, the receive UE 120 may attempt 5 PSCCH decodes for the 5 start-of-slot starting positions across the 5 subchannels and 3 PSCCH decodes for 3 mid-slot additional starting positions on 3 subchannels mapping to the 3 possible transmission configurations for a total of 8 PSCCH decodes. Additionally, or alternatively, when all starting positions are subject to a possible transmission configuration (e.g., start-of-slot starting positions may only be used for transmission when included in a possible transmission configuration), the receive UE 120 may further reduce a quantity of decodes to, for example, 3 PSCCH decodes for the 5 start-of-slot starting positions and 3 PSCCH decodes for 3 mid-slot additional starting positions mapping to the 3 possible transmission configurations for a total of 6 PSCCH decodes. In another particular example, when N=1, the only possible transmission configuration may be to occupy all subchannels in a resource pool. In this case, based at least in part on the quantity of transmission configurations being less than the quantity of subchannels, a quantity of PSCCH decodes is reduced, thereby reducing receive UE decoding complexity.

As indicated above, FIGS. 8A and 8B is provided as an example. Other examples may differ from what is described with respect to FIGS. 8A and 8B.

FIG. 9 is a diagram illustrating an example process 900 performed, for example, by a UE, in accordance with the present disclosure. Example process 900 is an example where the UE (e.g., UE 120) performs operations associated with transmission configurations for transmission in sidelink.

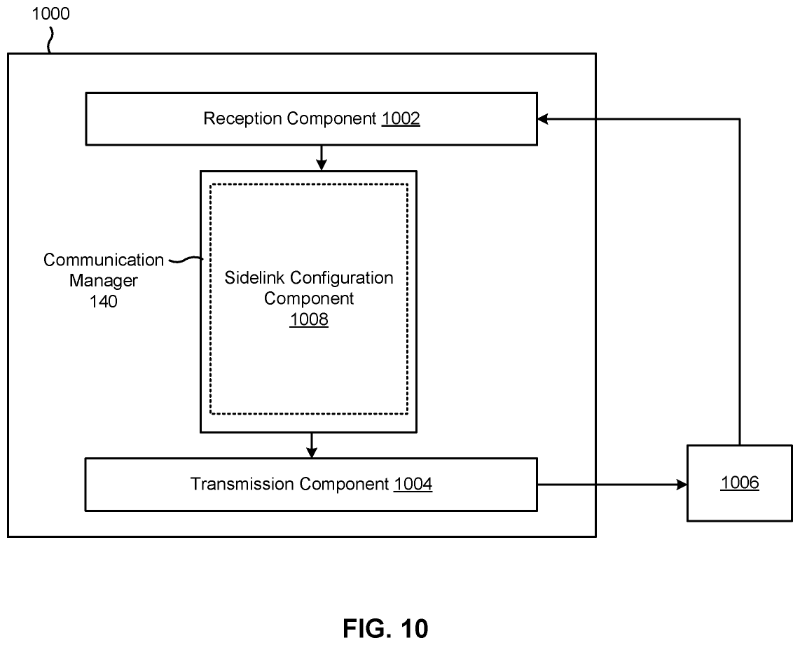

As shown in FIG. 9, in some aspects, process 900 may include receiving information identifying a subset of transmission configurations of a set of possible transmission configurations for a sidelink resource pool with a plurality of transmission starting positions (block 910). For example, the UE (e.g., using communication manager 140 and/or reception component 1002, depicted in FIG. 10) may receive information identifying a subset of transmission configurations of a set of possible transmission configurations for a sidelink resource pool with a plurality of transmission starting positions, as described above.

As further shown in FIG. 9, in some aspects, process 900 may include transmitting, in a transmission starting position of the plurality of transmission starting positions and on a sidelink, using a transmission configuration of the subset of transmission configurations (block 920). For example, the UE (e.g., using communication manager 140 and/or transmission component 1004, depicted in FIG. 10) may transmit, in a transmission starting position of the plurality of transmission starting positions and on a sidelink, using a transmission configuration of the subset of transmission configurations, as described above.

Process 900 may include additional aspects, such as any single aspect or any combination of aspects described below and/or in connection with one or more other processes described elsewhere herein.

In a first aspect, transmitting using the transmission configuration comprises transmitting using one or more subchannels, of a set of subchannels of the unlicensed spectrum band, corresponding to the transmission configuration.

In a second aspect, alone or in combination with the first aspect, receiving the information identifying the subset of transmission configurations comprises receiving a radio resource control message identifying an entry in a stored look-up table.

In a third aspect, alone or in combination with one or more of the first and second aspects, the transmission configuration is selected from the subset of transmission configurations based at least in part on a prior reservation of resources.

In a fourth aspect, alone or in combination with one or more of the first through third aspects, the subset of transmission configurations one-to-one maps to a set of physical sidelink control channel occasions.

In a fifth aspect, alone or in combination with one or more of the first through fourth aspects, the subset of transmission configurations is for a subset of the plurality of transmission starting positions or an entirety of the plurality of transmission starting positions.

In a sixth aspect, alone or in combination with one or more of the first through fifth aspects, the information identifying the subset of transmission configurations is a bitmap.

In a seventh aspect, alone or in combination with one or more of the first through sixth aspects, the bitmap identifies one or more subchannels of a resource pool occupied by the transmission configuration”

In an eighth aspect, alone or in combination with one or more of the first through seventh aspects, the subset of transmission configurations is applicable to a single resource block set, a plurality of different resource block sets, or a bandwidth part.

In a ninth aspect, alone or in combination with one or more of the first through eighth aspects, each resource block set, of the plurality of different resource block sets is associated with a corresponding subset of transmission configurations.

In a tenth aspect, alone or in combination with one or more of the first through ninth aspects, a quantity of subchannels in each transmission configuration of the subset of transmission configurations is more than a configured maximum.

In an eleventh aspect, alone or in combination with one or more of the first through tenth aspects, a quantity of subchannels in each transmission configuration is a minimum quantity of subchannels per resource block set or among a group of resource block sets.

In a twelfth aspect, alone or in combination with one or more of the first through eleventh aspects, the information identifying the subset of transmission configurations is associated with a starting or leading subchannel of a transmission.

In a thirteenth aspect, alone or in combination with one or more of the first through twelfth aspects, the transmission configuration is associated with a subchannel size for one or more subchannels.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a sidelink configuration component 1008, among other examples.

In some aspects, the apparatus 1000 may be configured to perform one or more operations described herein in connection with FIGS. 8A-8B. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive information identifying a subset of transmission configurations of a set of possible transmission configurations for a sidelink resource pool with a plurality of transmission starting positions. The transmission component 1004 may transmit, in a transmission starting position of the plurality of transmission starting positions and on a sidelink, using a transmission configuration of the subset of transmission configurations. The sidelink configuration component 1008 may configure transmission at a transmission starting position on a sidelink.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

In some aspects, to support wider transmission bandwidths than those indicated above, the following options may be configured: Option 1: Reduce sidelink control information (SCI) search space in a half slot (starting at symbol #7) or in both starting symbols (symbol #0 and symbol #7). In this case, PSCCH and the starting subchannel of PSSCH occur within a subset of the total subchannels available in resource pool, (e.g., PSCCH only occupying even interlaces in each 20 MHz resource block (RB)-set at symbol #7 could reduce the number PSCCH candidates in 80 MHz and SCS=30 KHz case from 40 to 32). Option 2: In the half slot, group multiple (interlaced) subchannels into one jumbo subchannel and the frequency domain allocation is limited to jumbo subchannel grid. In this case, PSCCH occupies the leading subchannel of the jumbo subchannel in the half slot and the number of PSCCH candidates in frequency is reduced. Further, the frequency resource indicator value (FRIV) would allocate all the (interlaced) subchannels in the jumbo subchannel or multiple jumbo subchannels. In some aspects, a configuration may limit PSCCH search locations to a subset of subchannels in half slot to meet a blind SCI decoding limit per slot.

The following provides an overview of some Aspects of the present disclosure:

Aspect 1: A method of wireless communication performed by a user equipment (UE), comprising: receiving information identifying a subset of transmission configurations of a set of possible transmission configurations for a sidelink resource pool with a plurality of transmission starting positions; and transmitting, in a transmission starting position of the plurality of transmission starting positions and on a sidelink, using a transmission configuration of the subset of transmission configurations.

Aspect 2: The method of Aspect 1, wherein transmitting using the transmission configuration comprises: transmitting using one or more subchannels, of a set of subchannels of the unlicensed spectrum band, corresponding to the transmission configuration.

Aspect 3: The method of any of Aspects 1-2, wherein receiving the information identifying the subset of transmission configurations comprises: receiving a radio resource control message identifying an entry in a stored look-up table.

Aspect 4: The method of any of Aspects 1-3, wherein the transmission configuration is selected from the subset of transmission configurations based at least in part on a prior reservation of resources.

Aspect 5: The method of any of Aspects 1-4, wherein the subset of transmission configurations one-to-one maps to a set of physical sidelink control channel occasions.

Aspect 6: The method of any of Aspects 1-5, wherein the subset of transmission configurations is for a subset of the plurality of transmission starting positions or an entirety of the plurality of transmission starting positions.

Aspect 7: The method of any of Aspects 1-6, wherein the information identifying the subset of transmission configurations is a bitmap.

Aspect 8: The method of Aspect 7, wherein the bitmap identifies one or more subchannels of a resource pool occupied by the transmission configuration”

Aspect 9: The method of any of Aspects 1-8, wherein the subset of transmission configurations is applicable to a single resource block set, a plurality of different resource block sets, or a bandwidth part.

Aspect 10: The method of Aspect 9, wherein each resource block set, of the plurality of different resource block sets is associated with a corresponding subset of transmission configurations.

Aspect 11: The method of any of Aspects 1-10, wherein a quantity of subchannels in each transmission configuration of the subset of transmission configurations is more than a configured maximum.

Aspect 12: The method of any of Aspects 1-11, wherein a quantity of subchannels in each transmission configuration is a minimum quantity of subchannels per resource block set or among a group of resource block sets.

Aspect 13: The method of any of Aspects 1-12, wherein the information identifying the subset of transmission configurations is associated with a starting or leading subchannel of a transmission.

Aspect 14: The method of any of Aspects 1-13, wherein the transmission configuration is associated with a subchannel size for one or more subchannels.

Aspect 15: An apparatus for wireless communication at a device, comprising a processor, memory coupled with the processor, and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive information identifying a subset of transmission configurations of a set of possible transmission configurations for a sidelink resource pool with a plurality of transmission starting positions; and
transmit, in a transmission starting position of the plurality of transmission starting positions and on a sidelink, using a transmission configuration of the subset of transmission configurations.

2. The UE of claim 1, wherein the one or more processors, to transmit using the transmission configuration, are configured to:
transmit using one or more subchannels, of a set of subchannels of the sidelink, corresponding to the transmission configuration.

3. The UE of claim 1, wherein the one or more processors, to receive the information identifying the subset of transmission configurations, are configured to:
receive a radio resource control message identifying an entry in a stored look-up table.

4. The UE of claim 1, wherein the transmission configuration is selected from the subset of transmission configurations based at least in part on a prior reservation of resources.

5. The UE of claim 1, wherein the subset of transmission configurations one-to-one maps to a set of physical sidelink control channel occasions or is for a subset of the plurality of transmission starting positions or an entirety of the plurality of transmission starting positions.

6. (canceled)

7. The UE of claim 1, wherein the information identifying the subset of transmission configurations is a bitmap, wherein the bitmap identifies one or more subchannels of a resource pool occupied by the transmission configuration.

8. (canceled)

9. The UE of claim 1, wherein the subset of transmission configurations is applicable to a single resource block set, a plurality of different resource block sets, or a bandwidth part.

10. The UE of claim 9, wherein each resource block set, of the plurality of different resource block sets is associated with a corresponding subset of transmission configurations.

11. The UE of claim 1, wherein a quantity of subchannels in each transmission configuration of the subset of transmission configurations is more than a configured maximum, or is a minimum quantity of subchannels per resource block set or among a group of resource block sets.

12. (canceled)

13. The UE of claim 1, wherein the information identifying the subset of transmission configurations is associated with a starting or leading subchannel of a transmission.

14. The UE of claim 1, wherein the transmission configuration is associated with a subchannel size for one or more subchannels.

15. A method of wireless communication performed by a user equipment (UE), comprising:
receiving information identifying a subset of transmission configurations of a set of possible transmission configurations for a sidelink resource pool with a plurality of transmission starting positions; and
transmitting, in a transmission starting position of the plurality of transmission starting positions and on a sidelink, using a transmission configuration of the subset of transmission configurations.

16. The method of claim 15, wherein transmitting using the transmission configuration comprises:
transmitting using one or more subchannels, of a set of subchannels of the sidelink, corresponding to the transmission configuration.

17. The method of claim 15, wherein receiving the information identifying the subset of transmission configurations comprises:
receiving a radio resource control message identifying an entry in a stored look-up table.

18. The method of claim 15, wherein the transmission configuration is selected from the subset of transmission configurations based at least in part on a prior reservation of resources.

19. The method of claim 15, wherein the subset of transmission configurations one-to-one maps to a set of physical sidelink control channel occasions, or is for a subset of the plurality of transmission starting positions or an entirety of the plurality of transmission starting positions.

20. (canceled)

21. The method of claim 15, wherein the information identifying the subset of transmission configurations is a bitmap, wherein the bitmap identifies one or more subchannels of a resource pool occupied by the transmission configuration.

22. (canceled)

23. The method of claim 15, wherein the subset of transmission configurations is applicable to a single resource block set, a plurality of different resource block sets, or a bandwidth part.

24. (canceled)

25. The method of claim 15, wherein a quantity of subchannels in each transmission configuration of the subset of transmission configurations is more than a configured maximum, or is a minimum quantity of subchannels per resource block set or among a group of resource block sets.

26.-29. (canceled)

30. An apparatus for wireless communication, comprising:
means for receiving information identifying a subset of transmission configurations of a set of possible transmission configurations for a sidelink resource pool with a plurality of transmission starting positions; and
means for transmitting, in a transmission starting position of the plurality of transmission starting positions and on a sidelink, using a transmission configuration of the subset of transmission configurations.
